(19) United States
(12) Patent Application Publication
(10) Pub. No.: US 2012/0198716 A1
(43) Pub. Date: Aug. 9, 2012

(54) Gauge for aligning hair trimmer blades

(76) Inventors: Alan Russell Tonges, Trumball, CT (US); Alex Banard Beaujour, Stratford, CT (US)

(21) Appl. No.: 12/931,713

(22) Filed: Feb. 8, 2011

(51) Int. Cl. G01B 1/00

(52) U.S. Cl. 33/641

(57) ABSTRACT

A gauge for setting the trimmer blades of a vibratory hair trimmer comprising of a gauge block with a slot in it of the shape of a perfectly adjusted set of trimmer blades.

One embodiment, the gauge block has a hole in the front that would line up with hole in the front of the trimmer blade set. A pin with a diameter slightly smaller is inserted into the hole and pushed up with the thumb. The pin cantilevers on the edge of the hole and forces the front blade down into the slot. The back blade is forced down with the forefinger as the adjustment screws are tightened.

Another embodiment has a spring clipped to the front of the front blade of the blade set and forces it into the groove when the adjustment screws are tightened.

This application claims the benefit of provisional patent application Ser. No. 61/274,035, Confirmation No. 4783, filed 2009 Aug. 12 by the present inventors.

This invention, the blade setter, is a gauge to set the distance and parallelism between the stationary blade and the movable blade of a vibratory hair trimmer.

### BACKGROUND

### Prior Art

Wahl Clipper Corporation blade adjustment fixture see pages A & B.

Barbers have to reset the blades of a vibratory trimmer by eye when the blades move out of alignment from use.

The only other gauge known is made by a company for a specific blade marketed by its own company. Its limitations are that the blade set is laid onto the gauge and when the adjustment screws are tightened, the blades often tend to shift out of alignment.

### SUMMARY

The blade setter is a block with a slot with a stepped groove at the base of the slot. The set of blades are restricted from movement out of adjustment by the shape of the groove and (embodiment 1) the force of a pin or (embodiment 2) the force of a spring.

### ADVANTAGES

Accordingly, two advantages are as follows:

(a) The block has a slot that has the exact form of a perfectly adjusted set of blades in it. The set of blades are restricted from movement by this form.

(b) A spring embodiment (1) or a pin embodiment (2) hold the blade set in place while the adjustment screws are tightened.

### DRAWINGS—FIGURES

FIG. 1A shows a gauge with a set of trimmer blades and a pin.

FIG. 1B shows a gauge block with a hole for a pin.

FIG. 1C shows a pin.

FIG. 1D shows a hand holding a gauge with a set of blades and a pin ready for screws to be tightened.

FIG. 1E shows a cutaway of a gauge with a set of blades and pin installed.

FIG. 2A shows a gauge with a set of blades and a spring installed.

FIG. 2B shows a gauge block.

FIG. 2C shows a side view of a spring.

FIG. 2D shows a side view of a gauge block with a set of blades and a spring installed.

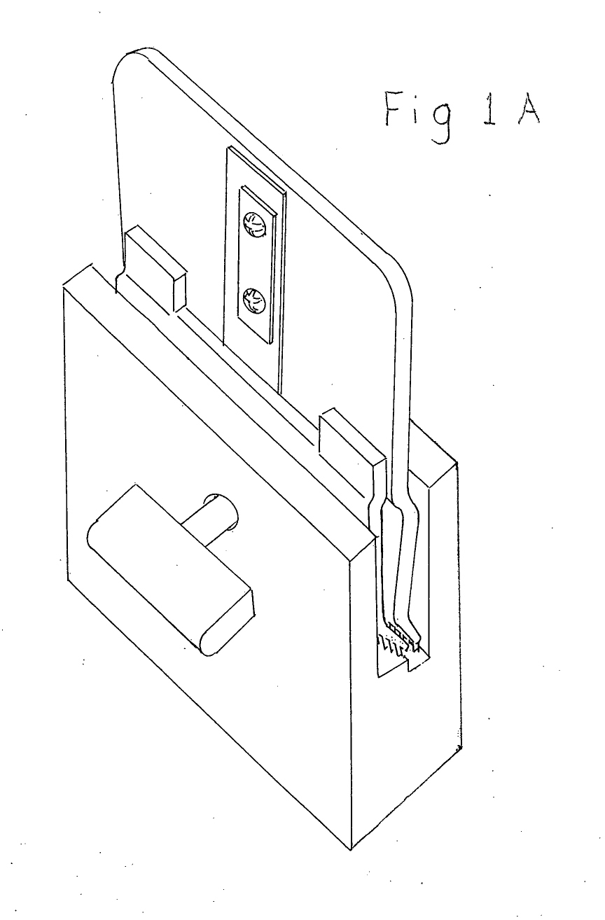

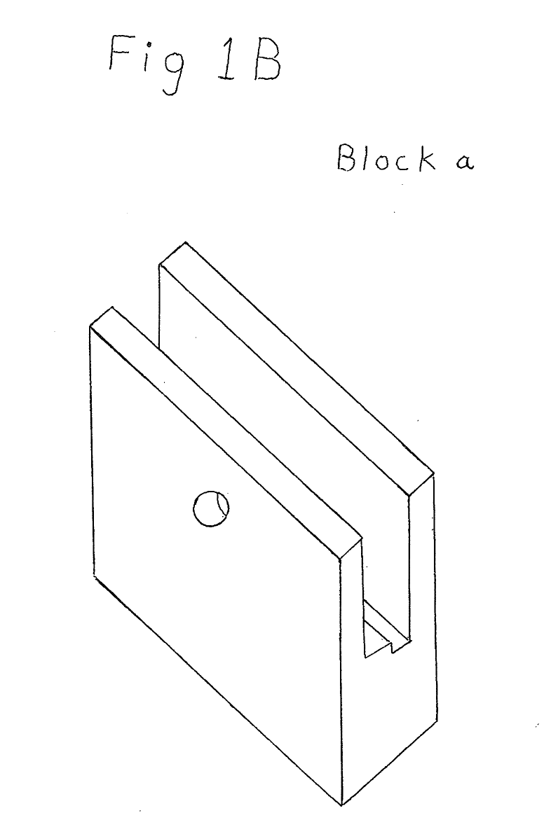

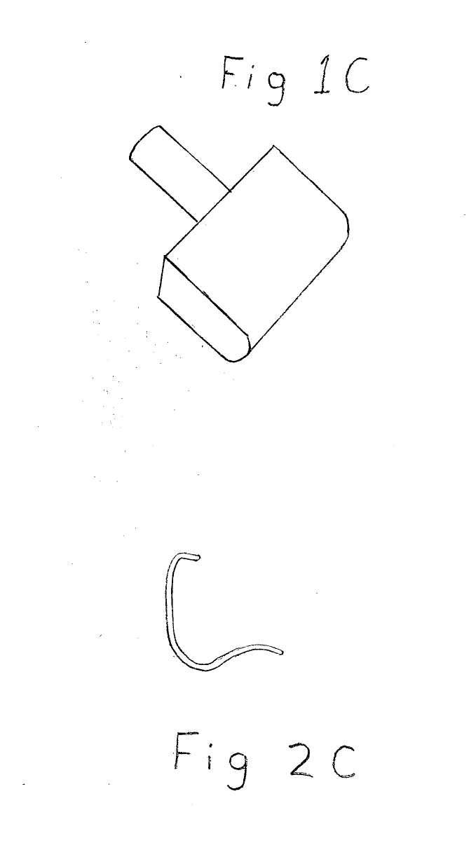

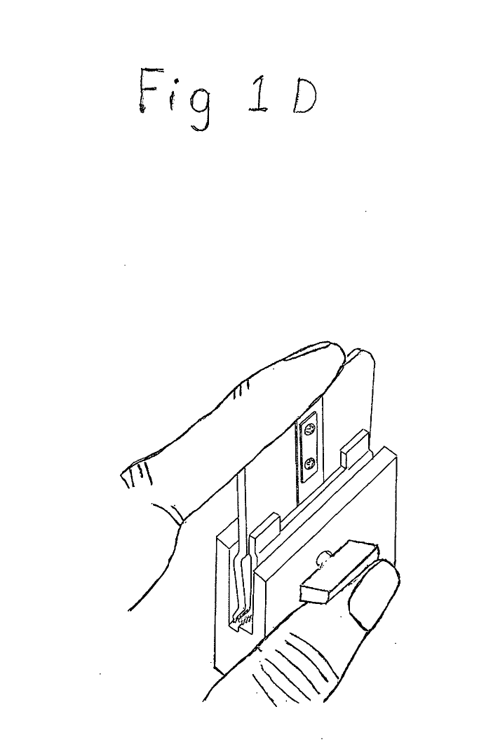

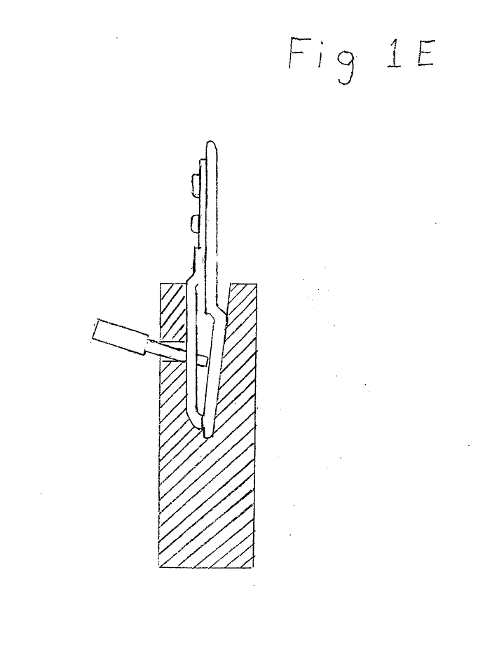

### DETAILED DESCRIPTION-FIGS. 1B AND 1C

### First Embodiment

One embodiment FIG. 1B shows the gauge block (a) with stepped slot. The front of the said gauge block has a hole to be used as a pivot point for the pin (b). FIG. 1C shows the said pin (b). This said pin's diameter is slightly smaller than the hole in said gauge block (b).

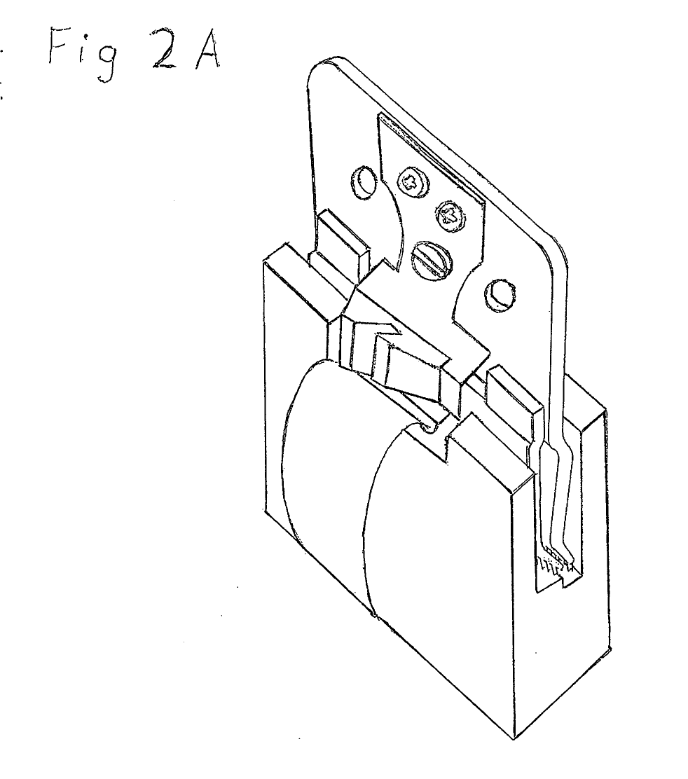

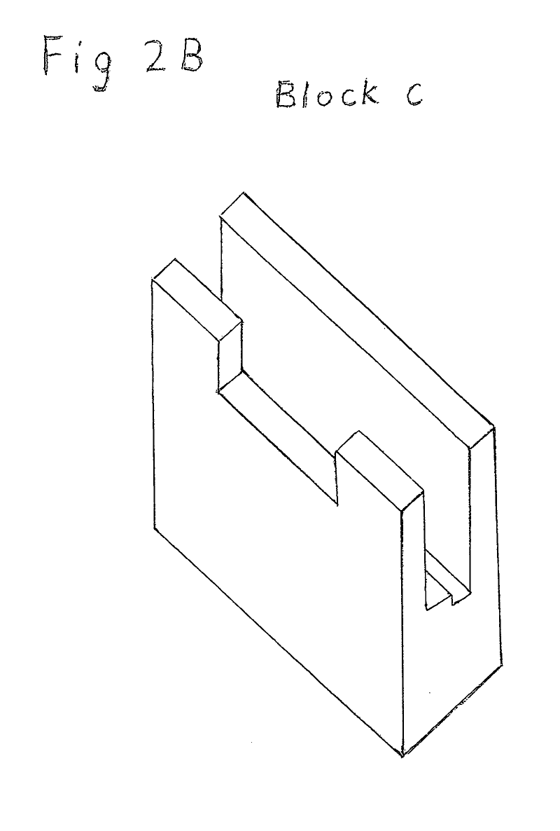

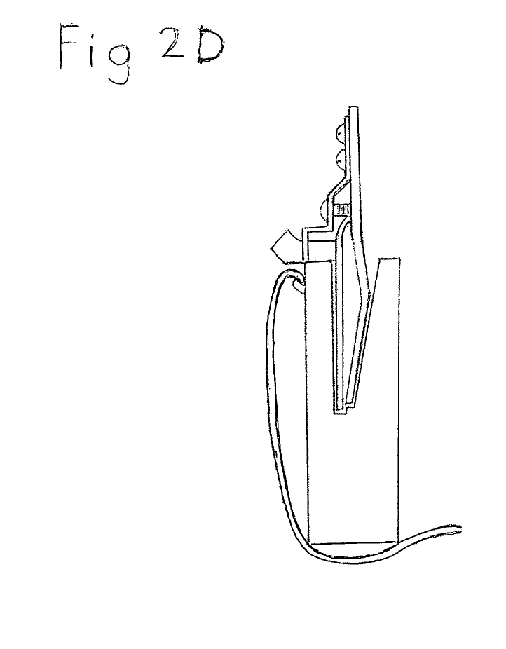

### DETAILED DESCRIPTION-FIGS. 2B AND 2C

### Second Embodiment

The second embodiment FIG. 2B shows gauge block (c) with stepped slot. The front of the said gauge block (c) has a clearance cutaway for the style of blade set to be adjusted. FIG. 2C shows a spring clip (d). This attaches to the front piece of the set of blades and swings under the bottom of the said gauge block (c) and clips under it.

### Operation

The user removes the blades that are to be adjusted from the vibratory trimmer and then loosens the alignment screws slightly. The user then installs the set of blades into the slot of the blade setter gauge.

### First Embodiment-FIGS. 1C, 1D, 1E

The user places the pin (b) FIG. 1C into the hole in the front of the blade setter gauge block (a), making sure that the hole in the movable blade is behind the hole in the blade setter gauge block (a) FIG. 1E. The blade setter gauge block (a) with the blades and pin (b) inserted can be in one hand as shown: FIG. 1D. The pin (b) is being pushed upward with the thumb FIG. 1E. The fact that the hole in the blade setter gauge block (a) is slightly larger than the pin (b) diameter, allows the pin (b) to cantilever on the edge of the hole of the blade setter gauge block (a). The upward force of the thumb forces the front blade down into the corresponding groove of the blade setter gauge block (a). At the same time, the forefinger of the same hand is forcing the back blade into the corresponding groove FIG. 1D. As the blade setter gauge block (a) equipped with blades and pin (b) are held in one hand as described previously, the other hand is used to hold a screwdriver to tighten the alignment screws. Now the blades can be installed in the vibratory trimmer.

### Second Embodiment-FIGS. 2A, 2D

The user takes the spring (d) and hooks onto a protruding piece of the shuttle mechanism of the movable blade. While holding the blade setter gauge block (c) in one hand, the other hand can take the spring (d) that is hooked to the protruding part of the movable blade and swing the lower part of the spring so that it clips under the blade setter gauge block (c) bottom and allowed to snap and lock behind it FIG. 2D. This keeps the spring in place FIG. 2A. Now the user can hold the blade setter with the spring in place in one hand and the other hand is used to hold a screwdriver to tighten the alignment screws. Now the blades can be installed in the vibratory trimmer.

### Advantages

(a) The gauge block has a slot that has the exact form of a perfectly adjusted set of trimmer blades. When installed, the set of blades are restricted from movement by this form.

(b) A pin embodiment (1) or spring embodiment (2) hold the blade set in place while the adjustment screws are tightened.

### Conclusion, Ramifications, and Scope

The shape of the back of the pin need not be a rectangle or square. The handle part of the pin can be many shapes. The shape of the outside of the gauge block need not be a rectangle, it can be many shapes.

CLAIMS: A gauge for setting the blades of a vibratory hair trimmer so that it cuts the hair as close to the skin as possible without cutting the skin.

I claim:

1. A block comprising:
(a) Having a slot in it with the form of the cross section of a perfectly matched set of trimmer blades, wherein the improvement comprises the said slot confines the said set of blades in a way whereby they cannot be allowed to be shifted out of alignment when the adjustment screws are tightened.

2. (b) Said block having a hole near the center of the front of the said block that corresponds to a hole in the moveable blade of the said set of blades.
(c) A pin that goes into the said hole in the said block and lines up with the said hole of the said moveable blade, wherein the improvement comprises: pressure of the thumb upward on the said pin pivots the said pin on the edge of the said hole in the said block forcing the said moveable blade into its corresponding groove in the slot of the said block.

3. (c) A spring is hooked onto the front piece of the said moveable blade that is exposed in the front of the said block through a cutaway in the front of the said block. Said spring swings under the said block wherein the improvement comprises: forcing the said movable blade into its corresponding said groove in the slot of the said block.
